(19) United States
(12) Patent Application Publication
(10) Pub. No.: US 2025/0127337 A1
(43) Pub. Date: Apr. 24, 2025

(54) MILK FROTHER

(71) Applicant: Batten Industries Inc., North Vancouver (CA)

(72) Inventor: James Roberts, West Vancouver (CA)

(21) Appl. No.: 18/834,573

(22) PCT Filed: Feb. 1, 2022
(86) PCT No.: PCT/CA2022/050147

§ 371 Date: Jul. 30, 2024

(51) Int. Cl. A47J 43/044; A47J 31/44; A47J 43/07; B01F 27/118; B01F 27/85; B01F 33/501; B01F 35/32; B01F 101/07

(52) U.S. Cl. CPC A47J 43/044; A47J 31/4496; A47J 43/0711; B01F 27/118; B01F 27/85; B01F 33/5011; B01F 35/3204; B01F 35/3215; A47J 2043/04409; B01F 2101/07; B01F 2215/0422

(57) ABSTRACT

A milk frother comprises a housing, a motor, a power supply, two rods, and two aerating members. The motor is located within the housing, with the motor comprising a rotatable shaft. The power supply is located within the housing, with the power supply configured to supply electrical power to the motor to effect rotation of the shaft. The two rods extend through the housing, with each of the rods comprising first and second ends. Each of the rods are operably coupled to the shaft proximate to the first ends, and rotation of the shaft effects rotation of the rods. Each of the aerating members is connected to one of the two rods proximate to the second ends. Rotation of the rods effects rotation of the aerating members to produce froth when the aerating members are placed within the milk.

### FIELD OF THE INVENTION

The invention relates to milk frothers, and in particular, to portable milk frothers.

### BACKGROUND OF THE INVENTION

Milk frothers are utensils that are used to generate milk froth, which may be then added to coffee drinks (e.g. cappuccinos, lattes, etc.). They typically operate by introducing air into the milk, creating a foamy consistency for the froth.

With the popularity of home appliances that are able to produce coffee drinks, there is a desire for a milk frother that is both easy to use and able to generate froth.

These and other objects will be better understood by reference to this application as a whole. Not all of the objects are necessarily met by all embodiments of the invention described below.

### SUMMARY OF THE INVENTION

In one aspect, a milk frother in accordance with the invention comprises a housing, a motor, a power supply, two rods, and two aerating members. The motor is located within the housing, with the motor comprising a rotatable shaft. The power supply is located within the housing, with the power supply configured to supply electrical power to the motor to effect rotation of the shaft. The two rods extend through the housing, with each of the rods comprising first and second ends. Each of the rods are operably coupled to the shaft proximate to the first ends, and rotation of the shaft effects rotation of the rods. Each of the aerating members is connected to one of the two rods proximate to the second ends. Rotation of the rods effects rotation of the aerating members to produce froth when the aerating members are placed within the milk.

In another aspect, each of the rods comprises first and second portions. The first portion extends from the first end and the second portion extends from the second end. The first portion is attached to the second portion at an angle.

In yet another aspect, the aerating members are connected to the second portions.

In a further aspect, the aerating members comprise coils.

In yet a further aspect, the first portions are angled apart such that a first distance between the first portions proximate to the first ends is less than a second distance between the first portions proximate to where the second portions are attached to the first portions.

In yet another aspect, an angle between the first portions is greater than 0° and less than 10°.

In still yet a further aspect, the angle between the first portions is between 1° and 5°.

In another aspect, the angle between the first portions is between 3° and 4°.

In yet another aspect, a first one of the first portions has a first length and a second one of the first portions has a second length, with the first length and the second length are the same.

In still yet another aspect, a first one of the first portions has a first length and a second one of the first portions has a second length, with the first length being greater than the second length.

In a further aspect, the shaft comprises a shaft gear, with each of the rods comprising a rod gear proximate to the first end. The shaft gear meshedly engages with each of the rod gears, and rotation of the shaft gear effects rotation of the rod gears.

In still a further aspect, the housing comprises a housing end through which the rods extend.

In still yet a further aspect, each of the rods further comprises a sleeve member surrounding at least a portion of the first portion. The sleeve member is adapted to allow for rotation of the first portion therewithin. The sleeve member is fixedly attached to the housing end.

In still a further aspect, the housing comprises a switch for selectively controlling the supply of electrical power to the motor.

In another aspect, a milk frother for frothing milk comprises a housing, two motors, a power supply, two rods, and two aerating members. The two motors are located within the housing, with each of the motors comprising a rotatable shaft. The power supply is also located within the housing, with the power supply configured to supply electrical power to the motors to effect rotation of the shafts. The two rods extend through the housing, with each of the rods comprising first and second ends. Each of the rods are operably coupled to one of the shafts proximate to the first ends. Rotation of the shafts effects rotation of the rods. Each of the aerating members is connected to one of the two rods proximate to the second ends.

Rotation of the rods effects rotation of the aerating members to produce froth when the aerating members are placed within the milk.

In yet another aspect, the motors are configured to rotate the shafts in opposite directions to each other.

The foregoing was intended as a summary only and of only some of the aspects of the invention. It was not intended to define the limits or requirements of the invention. Other aspects of the invention will be appreciated by reference to the detailed description of the embodiments.

### BRIEF DESCRIPTION OF THE DRAWINGS

The preferred embodiment of the invention will be described by reference to the drawings thereof, in which:

FIG. 1 depicts a milk frother in accordance with one embodiment of the invention;

FIG. 2 is a partial sectional front view of a milk frother in accordance with one embodiment;

FIG. 3 is a partial sectional top view of the milk frother of FIG. 2;

FIG. 4 shows the milk frother of FIG. 2 when viewed from one end;

FIG. 5 shows the rod gears and shaft gear of the milk frother;

FIG. 6 is another partial sectional view of the milk frother of FIG. 2;

FIG. 7 is a partial sectional view of another embodiment of the milk frother; and

FIGS. 8 to 10 show other possible embodiments of the milk frother.

### DETAILED DESCRIPTION

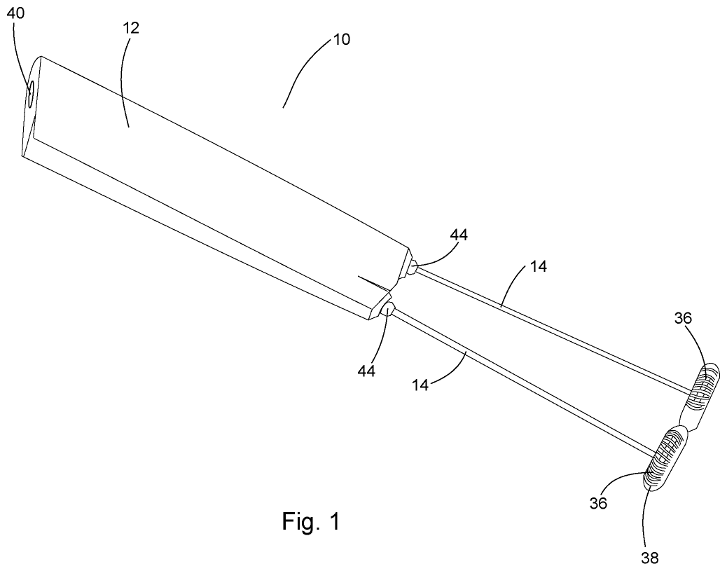

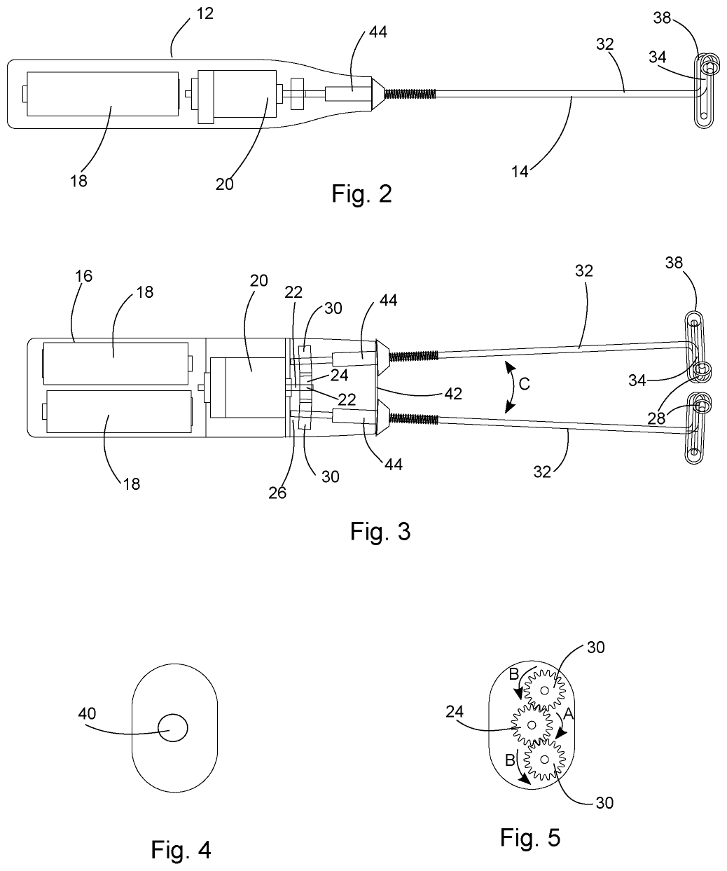

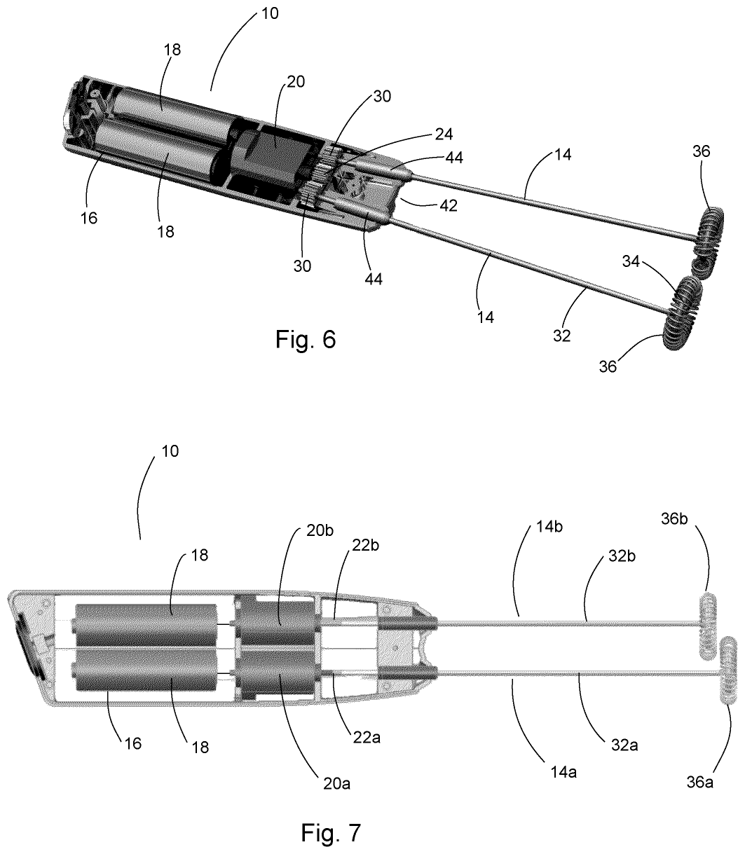

Referring to FIGS. 1 to 6, a milk frother 10 in accordance with one embodiment of the present invention comprises a housing 12 and two rods 14 extending from within and out of the housing 12. The housing 12 may be generally cylindrical or tubular in shape; however, it is understood that other shapes for the housing 12 are also possible.

The milk frother 10 further comprises a power supply 16, which is preferably contained within the housing 12. In one embodiment, the power supply 16 comprises one or more batteries 18. The milk frother 10 further comprises a motor 20, which is also preferably contained within the housing 12. The motor 20 is configured to receive electrical power from the power supply 16 and to drive rotation of the rods 14.

Referring to FIG. 3, in one embodiment, the motor 20 comprises a rotatable shaft 22. The shaft 22 is operably connected to the rods 14 such that rotation of the shaft 22 will also cause rotation of the rods 14. This rotation may be carried out through a shaft gear 24 fixedly located on the shaft 22. Each of the rods 14 have first and second ends 26, 28, with each of the rods 14 comprising a rod gear 30 fixedly located proximate to the first end 26. Each of the rod gears 30 meshedly engages with the shaft gear 24. When the motor 20 effects rotation of the shaft 22 (e.g. when electrical power is supplied to the motor 20 from the power supply 16), the rotation of the shaft 22 will in turn effect rotation of the shaft gear 24. Because of the meshed engagement of the shaft gear 24 with each of the rod gears 30, rotation of the shaft gear 24 will also effect rotation of each of the rod gears 30, which in turn will effect rotation of each of the rods 14.

Referring to FIG. 5, because of the arrangement of the shaft gear 24 and the rod gears 30, when the shaft gear 24 rotates in one direction (i.e. direction A), the rod gears 30 will both rotate in the opposite direction (i.e. direction B) to the shaft gear 24. In other words, both of the rod gears 30 will rotate in the same direction.

Each of the rods 14 preferably comprises first and second portions 32, 34 that are preferably generally tubular. The first portion 32 extends from the first end 26 and is preferably straight for substantially its entire length. The second portion 34 extends from the second end 28 and is attached to the first portion 32 at an angle, preferably approximately 90°. In other words, a longitudinal axis of the first portion 32 intersects with a longitudinal axis of the second portion 34 at an angle, preferably approximately 90°. Other angles are also possible.

An aerating member 36 is attached to the second portion 34. In the embodiment shown in FIG. 1, the aerating member 36 comprises a coil 38 formed into a circular arrangement. It is understood that other shapes and arrangements for the aerating members 36 are also possible.

Referring to FIG. 3, in one embodiment, the first portions 32 of the rods 14 are not arranged parallel to each other but are instead arranged at an angle C such that a distance between the first portions 32 at their first ends 26 is less than a distance between the first portions 32 where the second portions 34 are attached thereto. The angle C may be greater than 0° and less than 10°, or more preferably between 1° and 5°, or even more preferably between 3° and 4°. Preferably, the angle C, the lengths of the first portions 32, and the widths of the aerating members 36 are such so that the aerating members 36 do not interfere with each other when rotating.

For example, referring to FIG. 3, the housing 12 comprises a housing end 42 through which the first portions 32 extend. Each of the rods 14 may comprise a sleeve member 44 that surrounds at least a portion of the first portions 32 proximate to where the first portions 32 extend through the housing end 42. Although the sleeve member 44 surrounds a portion of the first portion 32, the sleeve member 44 is not fixedly attached to the first portion 32, which means that the first portion 32 is able to rotate freely within the sleeve member 44 without requiring the sleeve member 44 to rotate. The sleeve members 44 are fixedly attached to the housing end 42, thereby holding the rods 14 in place with respect to the housing 12. Furthermore, the fixed attachment of the sleeve members 44 to the housing end 42 allows the angle C to be fixed and to remain constant, regardless of the rotation of the rods 14.

When the milk frother 10 is used in operation, the milk frother 10 is first partially inserted into a container of milk (or some other suitable frothable liquid) until the aerating members 36 are at or below the level of the milk (or liquid). The milk frother 10 can then be turned on, such as by depressing or otherwise activating a switch 40 located on the housing 12. The switch 40 is configured to be electrically connected to the power supply 16 and the motor 20 such as to allow for electrical power to be selectively supplied from the power supply 16 to the motor 20, which in turns causes the shaft 22 (and thereby the rods 14) to rotate. Rotation of the rods 14 will in turn cause the aerating members 36 to rotate within the milk (or liquid). This rotation of the aerating members 36 within the milk (or liquid) introduces air into the milk (or liquid), thereby generating the froth.

In the embodiment shown in FIGS. 1 to 6, the rods 14 have lengths that are substantially similar to each other. However, referring to FIG. 7, in another embodiment, the rods 14 may have different lengths. For example, the rods 14 (shown as 14a and 14b in FIG. 7) may differ in length such that the rod 14a is longer than the rod 14b. In this embodiment, the first portions 32a, 32b may be arranged substantially parallel to each other. Furthermore, preferably, the lengths of the rods 14a, 14b are such that aerating members 36a, 36b are arranged the aerating member 36b is located entirely above the aerating member 36a. This staggered arrangement of the aerating members 36a, 36b may promote more turbulent mixing of the air into the milk (or liquid) by having the aerating members 36a, 36b rotating in different planes within the milk (or liquid), which may in turn produce a froth of better quality.

Referring still to FIG. 7, in this embodiment, two of the motors 20 (shown as 20a and 20b in FIG. 7) are located in the housing 12. Each of the shafts 22 of the motors 20 are coupled to one of the rods 14 (i.e. the shaft 22a of the motor 20a is coupled to the rod 14a, and the shaft 22b of the motor 20b is coupled to the rod 14b). The motors 20 may also be configured to rotate in opposite directions to each other, such that when electrical power is suppled to the motors 20 by the power supply 16 (e.g. using the batteries 18), the shafts 22a, 22b (and thereby the rods 14a, 14b) will rotate in opposite directions to each other. The rotation of the rods 14a, 14b in opposite directions will result in the aerating members 36a, 36b also rotating in opposite directions. This rotational arrangement may again promote more turbulent mixing of the air into the milk (or liquid), which may in turn produce a froth of better quality.

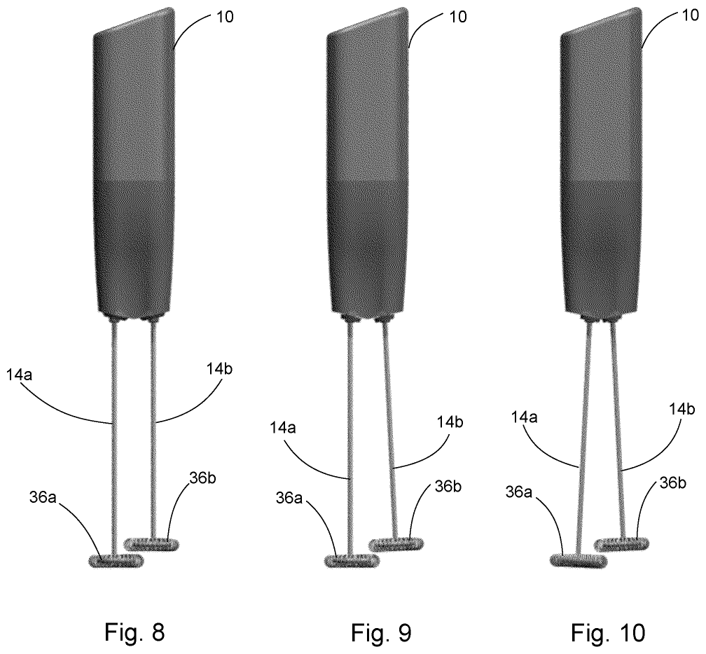

Referring to FIGS. 8 to 10, different arrangements for the rods 14 (shown as 14a and 14b in FIGS. 8 to 10) are possible. For example, in FIG. 8, the rods 14a, 14b are arranged substantially parallel to each other (similar to the embodiment shown in FIG. 7). In FIG. 9, the rods 14a, 14b are arranged such that they are angled apart. In FIG. 10, the rods 14a, 14b are also arranged such that they are angled apart, though even more so than shown in FIG. 9. Furthermore, in the embodiments shown in FIGS. 8 to 10, the lengths of the rods 14a, 14b may also differ from each other. For example, in the embodiments shown in FIGS. 8 to 10, the rod 14a is longer than the rod 14b. Preferably, the rod 14a is of sufficiently greater length than the rod 14b such that the rotation of the aerating member 36a does not interfere with the rotation of the aerating member 36b.

It will be appreciated by those skilled in the art that the preferred embodiment has been described in some detail but that certain modifications may be practiced without departing from the principles of the invention.

1. A milk frother for frothing milk, the milk frother comprising:
a housing;
a motor located within the housing, the motor comprising a rotatable shaft;
a power supply located within the housing, the power supply configured to supply electrical power to the motor to effect rotation of the shaft;
two rods extending through the housing, each of the rods comprising first and second ends, wherein each of the rods are operably coupled to the shaft proximate to the first ends, and wherein rotation of the shaft effects rotation of the rods; and
an aerating member connected to each of the two rods proximate to the second ends, wherein rotation of the rods effects rotation of the aerating members to produce froth when the aerating members are placed within the milk.

2. The milk frother of claim 1, wherein each of the rods comprises first and second portions, wherein the first portion extends from the first end and the second portion extends from the second end, and wherein the first portion is attached to the second portion at an angle.

3. The milk frother of claim 2, wherein the aerating members are connected to the second portions.

4. The milk frother of claim 1, wherein the aerating members comprise coils.

5. The milk frother of claim 2, wherein the first portions are angled apart such that a first distance between the first portions proximate to the first ends is less than a second distance between the first portions proximate to where the second portions are attached to the first portions.

6. The milk frother of claim 5, wherein an angle between the first portions is greater than 0° and less than 10°

7. The milk frother of claim 6, wherein the angle between the first portions is between 1° and 5°.

8. The milk frother of claim 7, wherein the angle between the first portions is between 3° and 4°.

9. The milk frother of claim 2, wherein a first one of the first portions has a first length and a second one of the first portions has a second length, and wherein the first length and the second length are the same.

10. The milk frother of claim 2, wherein a first one of the first portions has a first length and a second one of the first portions has a second length, and wherein the first length is greater than the second length.

11. The milk frother of claim 1, wherein the shaft comprises a shaft gear, wherein each of the rods comprises a rod gear proximate to the first end, wherein the shaft gear meshedly engages with each of the rod gears, and wherein rotation of the shaft gear effects rotation of the rod gears.

12. The milk frother of claim 1, wherein the housing comprises a housing end through which the rods extend.

13. The milk frother of claim 12, wherein each of the rods further comprises a sleeve member surrounding at least a portion of the first portion, the sleeve member adapted to allow for rotation of the first portion therewithin, and wherein the sleeve member is fixedly attached to the housing end.

14. The milk frother of claim 1, wherein the housing comprises a switch for selectively controlling the supply of electrical power to the motor.

15. A milk frother for frothing milk, the milk frother comprising:
a housing;
two motors located within the housing, each of the motors comprising a rotatable shaft;
a power supply located within the housing, the power supply configured to supply electrical power to the motors to effect rotation of the shafts;
two rods extending through the housing, each of the rods comprising first and second ends, wherein each of the rods are operably coupled to one of the shafts proximate to the first ends, and wherein rotation of the shafts effects rotation of the rods; and
an aerating member connected to each of the two rods proximate to the second ends, wherein rotation of the rods effects rotation of the aerating members to produce froth when the aerating members are placed within the milk.

16. The milk frother of claim 15, wherein the motors are configured to rotate the shafts in opposite directions to each other.

17. The milk frother of claim 15, wherein each of the rods comprises first and second portions, wherein the first portion extends from the first end and the second portion extends from the second end, and wherein the first portion is attached to the second portion at an angle.

18. The milk frother of claim 17, wherein the aerating members are connected to the second portions.

19. The milk frother of claim 17, wherein the first portions are angled apart such that a first distance between the first portions proximate to the first ends is less than a second distance between the first portions proximate to where the second portions are attached to the first portions.

20. The milk frother of claim 19, wherein an angle between the first portions is greater than 0° and less than 10°.

21. The milk frother of claim 20, wherein an angle between the first portions is between 1° and 5°.

22. The milk frother of claim 21, wherein the angle between the first portions is between 3° and 4°.
